(19) United States
(12) Patent Application Publication
(10) Pub. No.: US 2013/0276013 A1
(43) Pub. Date: Oct. 17, 2013

(54) Using Multimedia Search to Identify what Viewers are Watching on Television

(71) Applicant: Wenlong Li, Beijing (CN)

(72) Inventor: Wenlong Li, Beijing (CN)

(21) Appl. No.: 13/994,777

(22) PCT Filed: Sep. 12, 2011
(86) PCT No.: PCT/CN2011/001545

§ 371 Date: Jun. 17, 2013

(51) Int. Cl. H04N 21/84

(52) U.S. Cl. CPC H04N 21/84
USPC 725/20

(57) ABSTRACT

A television program currently being watched can be identified by extracting at least one decoded frame from a television transmission. The frame can be transmitted to a separate mobile device for requesting an image search and for receiving the search results. The search results can be used to identify the program, and the user's social networking friends can be notified of the program identification.

### BACKGROUND

This relates generally to television, including both broadcast and streaming television.

Television may be distributed by broadcasting television programs using radio frequency transmissions of analog or digital signals. In addition, television programs may be distributed over cable and satellite systems. Finally, television may be distributed over the Internet using streaming. As used herein, the term “television transmission” includes all of these modalities of television distribution. As used herein, “television” means the distribution of program content, either with or without commercials and includes both conventional television programs, as well as the distribution of video games.

Systems are known for determining what programs users are watching. For example, the IntoNow service records, on a cell phone, audio signals from television programs being watched, analyzes those signals, and uses that information to determine what programs viewers are watching. One problem with audio analysis is that it is subject to degradation from ambient noise. Of course, ambient noise in the viewing environment is common and, thus, audio based systems are subject to considerable limitations.

### BRIEF DESCRIPTION OF THE DRAWINGS

FIG. 1 is a high level architectural depiction of one embodiment of the present invention;

FIG. 2 is a block diagram of a set top box according to one embodiment of the present invention;

FIG. 3 is a flow chart for a mobile grabber in accordance with one embodiment of the present invention;

FIG. 4 is a flow chart for a multimedia grabber in accordance with one embodiment of the present invention;

FIG. 5 is a flow chart for a cloud based system for performing image searching in accordance with one embodiment of the present invention; and

FIG. 6 is a flow chart for a sequence for maintaining a table according to one embodiment.

### DETAILED DESCRIPTION

In accordance with some embodiments, a multimedia segment, such as limited duration electronic representation of video frame or clip, metadata or audio, may be grabbed from the actively tuned television channel currently being watched by one or more viewers. This multimedia segment may then be transmitted to a mobile device in one embodiment. The mobile device may then transmit the information to a server for searching. For example, image searching may ultimately be used to determine what program is being watched. Once the program is identified, then it is possible to provide the viewer with a variety of other services. These services can include the provision of additional content, including additional focused advertising content, social networking services, and program viewing recommendations.

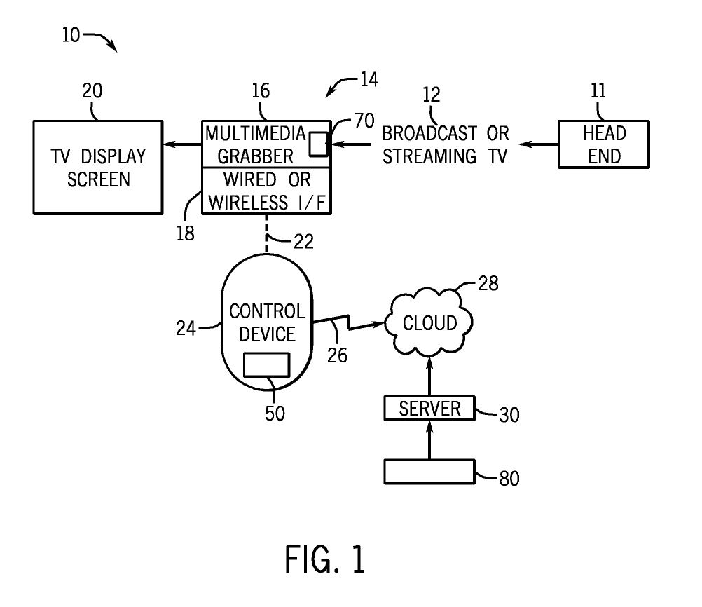

Referring to FIG. 1, a television screen 20 may be coupled to a processor-based device 14, in turn, coupled to a television transmission 12. This transmission may be distributed over the Internet or over the airwaves, including radio frequency broadcast of analog or digital signals, cable distribution, or satellite distribution. The processor-based system 14 may be a standalone device separate from the television receiver or may be integrated within the television receiver. It may, for example, include the components of a conventional set top box and may, in some embodiments, be responsible for decoding received television transmissions.

In one embodiment, the processor-based system 14 includes a multimedia grabber 16 that grabs a video frame or clip (i.e. a series of frames), metadata or sound from the decoded television transmission currently tuned to by a receiver (that may be part of the system 14 in one embodiment). The processor-based system 14 may also include a wired or wireless interface 18 which allows the multimedia that has been grabbed to be transmitted to an external control device 24. This transmission may be over a wired connection, such as a Universal Serial Bus (USB) connection, widely available in television receivers and set top boxes, or over any available wireless transmission medium 22, including those using radio frequency signals and those using light signals.

In other embodiments, undecoded content may be grabbed and decoded in the control device 24. As another option, the decoding may be done in the server 30.

The control device 24 may be a mobile device, including a cellular telephone, a laptop computer, a tablet computer, a mobile Internet device, or a remote control for a television receiver, to mention a few examples. The device 24 may also be non-mobile, such as a desk top computer or an entertainment system. The device 24 and the system 14 may be part of a wireless home network in one embodiment. Generally, the device 24 has its own separate display so that it can display information independently of the television display screen. In embodiments where the device 24 does not include its own display, a display may be overlaid on the television display, such as by a picture-in-picture display.

The control device 24, in one embodiment, may communicate with a cloud 28. In the case where the device 24 is a cellular telephone, for example, it may communicate with the cloud by cellular telephone signals 26, ultimately conveyed over the Internet. In other cases, the device 24 may communicate through hard wired connections, such as network connections, to the Internet. As still another example, the device 24 may communicate over the same transport medium that transported the television transmission. For example, in the case of a cable system, a device 24 may provide signals through the cable system to the cable head end or server 11. Of course, in some embodiments, this may consume some of the available transmission bandwidth. Thus, in some embodiments, the device 24 may not be a mobile device and may even be part of the processor-based system 14.

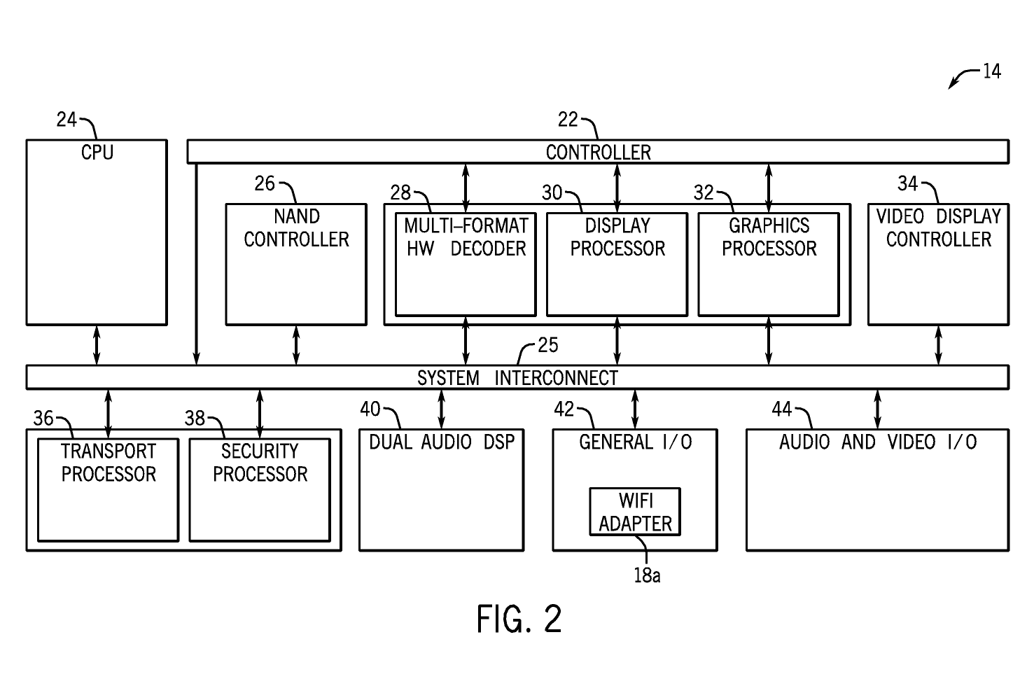

Referring to FIG. 2, one embodiment of the processor-based system 14 is depicted, but many other architectures may be used as well. The architecture depicted in FIG. 2 corresponds to the CE4100 platform, available from Intel Corporation. It includes a central processing unit 24, coupled to a system interconnect 25. The system interconnect is coupled to a NAND controller 26, a multi-format hardware decoder 28, a display processor 30, a graphics processor 32, and a video display controller 34. The decoder 28 and processors 30 and 32 may be coupled to a controller 22, in one embodiment.

The system interconnect may be coupled to transport processor 36, security processor 38, and a dual audio digital signal processor (DSP) 40. The digital signal processor 40 may be responsible for decoding the incoming video transmission. A general input/output (I/O) module 42 may, for example, be coupled to a wireless adaptor, such as a WiFi adaptor 18a. This will allow it to send signals to a wireless control device 24, in some embodiments. Also coupled to the system interconnect 25 is an audio and video input/output device. This may provide a decoded video output and may be used to output video frames or clips in some embodiments.

In some embodiments, the processor-based system 14 may be programmed to output multimedia segments upon the satisfaction of a particular criteria. One such criteria is the passage of time intervals. In such case, the video clip or frame is output on regular timed intervals. Another option is that the processor-based system 14 detects various activities in the incoming video transmission to trigger the multimedia segment grabbing. Examples of activities or events include a commercial, the end of a commercial, a program change, a tuning selection, a scene change, an audio level change, or television activation, to mention a few examples.

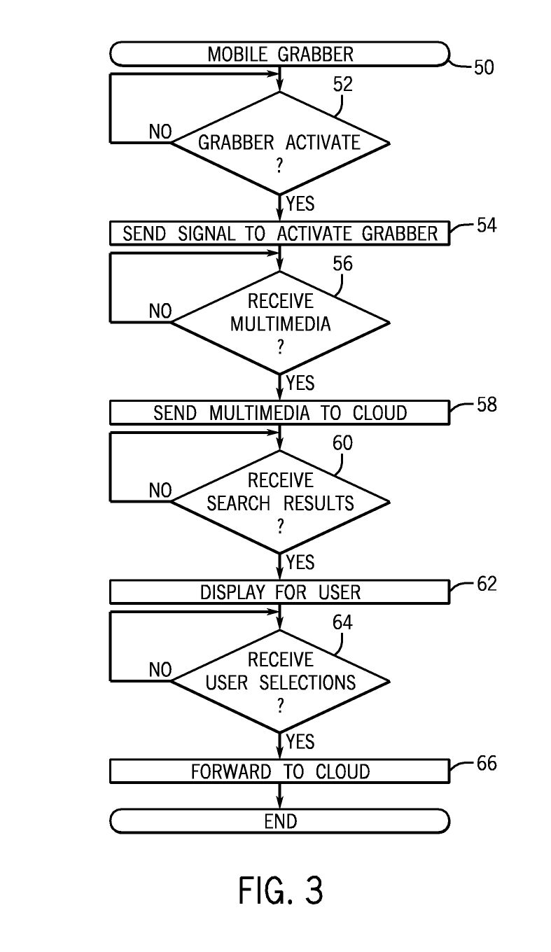

FIG. 3 shows a sequence for an embodiment of the control device 24. The sequence may be implemented in software, hardware, and/or firmware. In software or firmware based embodiments, the sequence may be implemented by computer executable instructions stored in a non-transitory computer readable medium, such as an optical, magnetic, or semiconductor storage device. For example, the software or firmware sequence may be stored in storage 50 on the control device 24.

While an embodiment is depicted in which the control device 24 is a mobile device, non-mobile embodiments are also contemplated. For example, the control device 24 may be integrated within the system 14.

Initially, a check at diamond 52 determines whether the grabber 16 has been activated, as indicated in diamond 52. In some embodiments, the grabber 16 is not always active so that the user can maintain, in relative confidence, the television programs that are being viewed. For example, the user may activate an application on the user's cell phone to initiate the grabbing activity and, in such case, the grabber activation is detected at diamond 52.

Then, at block 54, a signal may be sent from the control device 24 to the processor-based system 14 to initiate multimedia grabbing by the multimedia grabber 16. When the control device 24 receives a multimedia segment from the grabber 16, as detected at diamond 56, in some embodiments, the control device 24 may send a multimedia segment to the cloud 28 for image analysis. Of course, it can send the multimedia segment over a network to any server in other embodiments. It can also send the multimedia segment to the head end 11 for image, text, or audio analysis, as another example.

If digital signals carrying audio are captured and transmitted to the device 24, the captured signals carrying audio information may be converted to text, for example, in the control device 24, the system 14 or the cloud 28. Then the text can be searched to identify the television program.

Similarly, metadata from the grabber 16 may be analyzed to identify information to use in a text search to identify the program. In some embodiments, more than one of digital signals representing audio, metadata, video frames or clips, may be used as an input for keyword Internet or database searches.

An analysis engine then performs a multimedia search to identify the television program being viewed. This search may be a simple Internet or database search or it may be a more focused search. For example, the transmission in block 58 may include the current time or video capture and location of the control device 24. This information may be used to focus the search using information about what programs are being broadcast or transmitted at particular times and in particular locations. For example, a database may be provided on a website that correlates television programs available in different locations at different times and this database may be image searched to find an image that matches a captured frame to identify the program.

In some embodiments, the user may append annotations to the multimedia frame or clip at the device 24 to aid in program identification by focusing the searching.

The identification of the program may be done by using a visual search tool. The image frame or clip is matched to existing frames or clips within the search database. In some cases, a series of matches may be identified and, in such case, those matches may be sent back to the control device 24. When a check at diamond 60 determines that the search results have been received by the control device 24, the search results may be displayed for the user, as indicated at block 62. The control device 24 then receives the user selection of one of the search results that conforms to the information the user wanted, such as the correct program being viewed. Then, once the user selection has been received, as indicated in diamond 64, the selected search result may then forwarded to the cloud, as indicated in block 66. This allows the television program identification to be used to provide other services for the viewer or for third parties.

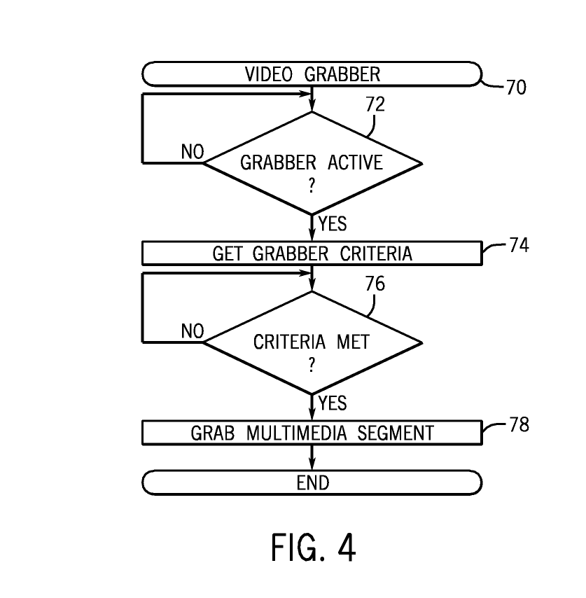

Next, referring to FIG. 4, a sequence 70 may be implemented within the processor-based system 14. Again, the sequence 70 may be implemented in firmware, hardware, and/or software. In software or firmware embodiments, it may be implemented by non-transitory computer readable media. For example, the multimedia grabber 70 may be stored in a storage 70 on the multimedia grabber device 16.

Initially, a check at diamond 72 determines whether the grabber feature has been activated. If so, the grabber criteria may be accessed, as indicated in block 74. The grabber criteria may be pre-stored within the processor-based system 14 or may be conveyed from the control device 24. In some embodiments, the user can select the criteria. Again, the criteria can be time based so that, at periodic intervals, a digital signal representing a frame, a clip, audio segment, or multimedia segment is grabbed. In other embodiments, other criteria may be used, including criteria based on video content analysis.

If the criteria has been met, as determined in diamond 76, multimedia is grabbed and transmitted to the control device 24, as indicated in block 78.

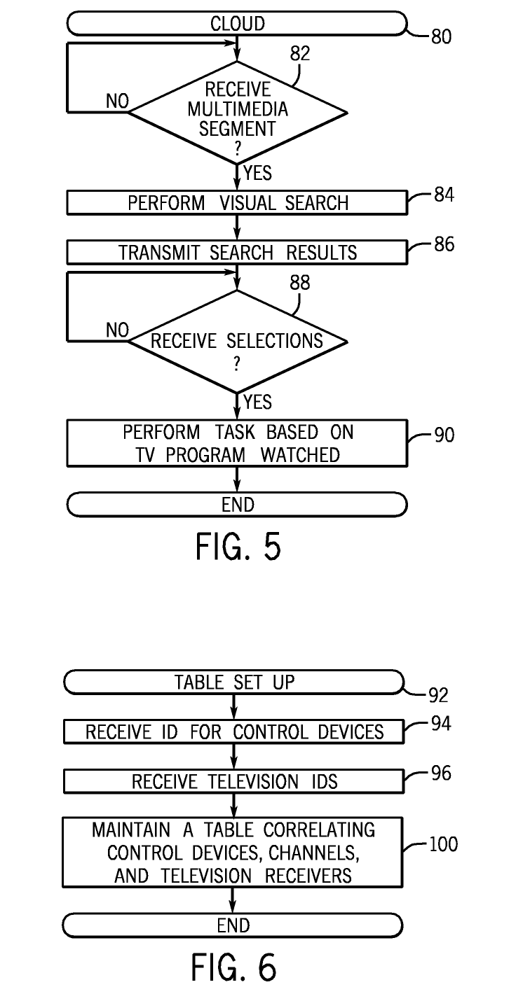

Referring to FIG. 5, the operation of the cloud 28, according to one embodiment, is indicated by the sequence 80. The sequence 80 may be implemented in software, firmware, and/or hardware. In software and firmware based embodiments, it may be implemented by non-transitory computer readable instructions. For example, the computer readable instructions can be stored in a storage 80, associated with a server 30, shown in FIG. 1.

While an embodiment using a cloud is illustrated, of course, the same sequence could be implemented by any server, coupled over any suitable network, by the control device 24 itself, by the processor-based device 14, or by the head end 11 in other embodiments.

Initially, a check at diamond 82 determines whether the multimedia segment has been received. If so, a visual search is performed, in the case where the multimedia is an electronic representation of a video frame or clip, as indicated in block 84. In the case of an electronic representation audio clip, the audio representation may be converted to text and searched. If the multimedia segment represents metadata, the metadata may be parsed for searchable content. Then, in block 86, the search results are transmitted back to the control device 24, for example. The control device 24 may receive user input or selection about which of the search results is most relevant. The system waits for the selection from the user and, when the selection is received, as determined in diamond 88, a task may be performed based on the television program being watched (block 90). For example, the task may be to provide information to a pre-selected group of friends for social networking purposes. The user's friends on Facebook may automatically be sent a message indicating which program the user is watching at the current time in one embodiment. Those friends can then interact over Facebook with the viewer to chat about the television program using the control device 24, for example.

As another example, the task may be to analyze demographic information about viewers and to provide information to the head end about the programs being watched by different users at different times. Still other alternatives include providing focused content to viewers watching particular programs. For example, the viewers may be provided information about similar programs coming up next. The viewers may be offered advertising information focused on what the viewer is currently watching. For example, if the ongoing television program highlights a particular automobile, the automobile manufacturer may provide additional advertising to provide viewers with more information about that vehicle that is currently being shown in the program. This information may be displayed as an overlay, in some cases, on the television screen, but may be advantageously displayed on a separate display associated with the control device 24, for example. In the case where the broadcast is an interactive game, information about the game progress can be transmitted to the user's social networking group. Similarly, advertising may be used and demographics may be collected in the same way.

In some embodiments, a plurality of users may be watching the same television program. In some households, a number of televisions may be available. Thus, many different users may wish to use the services described herein at the same time. To this end, the processor-based system 14 may maintain a table that keeps track of identifiers for the control devices 24, a television identifier and program information. This may allow users to move from room to room and still continue to receive the services described herein, with the processor-based system 14 simply adapting to different televisions, all of which receive their signal downstream of the processor-based system 14, in such an embodiment.

In some embodiments, the table may be stored in the processor-based system 14 or may be uploaded to the head end 11 or, perhaps, even may be uploaded through the control device 24 to the cloud 28.

Thus, referring to FIG. 6, in some embodiments, a sequence 92 may be used to maintain a table to correlate control devices 24, television display screens 20, and channels being selected. Then a number of different users can use the system through the same television, or at least two or more televisions that are all connected through the same processor-based system 14, for example, in a home entertainment network. The sequence may be implemented as hardware, software and/or firmware. In software and firmware embodiments, the sequence may be implemented using computer readable instructions stored on a non-transitory computer readable medium, such as a magnetic, semiconductor, or optical storage. In one embodiment, the storage 50 may be used.

Initially, the system receives and stores an identifier for each of the control devices that provides commands to the system 14, as indicated in block 94. Then, the various televisions that are coupled through the system 14 may be identified and logged, as indicated in block 96. Finally, a table is setup that correlates control devices, channels, and television receivers (block 100). This allows multiple televisions to be used that are connected to the same control device in a seamless way so that viewers can move from room to room and continue to receive the services described herein. In addition, a number of viewers can view the same television and each can independently receive the services described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
detecting occurrence of an event;
in response to detecting an event, automatically capturing an electronic decoded signal from a television program; and
performing a search using said signal to facilitate identification of the television program.

2. The method of claim 1 including capturing a signal including an electronic representation of a video frame or clip, audio or metadata.

3. The method of claim 1 wherein detecting the occurrence of an event includes detecting the passage of a time interval.

4. The method of claim 1 including automatically transferring said signal to a mobile device.

5. The method of claim 4 including providing search results to said mobile device.

6. The method of claim 4 including sending said signal to a remote server to perform said search.

7. The method of claim 1 including tracking a plurality of mobile devices, receiving requests from each of said devices, and providing responses to each device.

8. The method of claim 7 including maintaining a table correlating mobile devices, televisions, and requests from mobile devices.

9. The method of claim 1 including automatically distributing said identification using a social networking tool.

10. The method of claim 1 including enabling a user to use one mobile device to receive decoded signals from two different televisions at different times.

11. At least one non-transitory computer readable medium storing instructions to enable a computer to:
detect the occurrence of an event;
in response to detection of an event, automatically capture an electronic decoded signal from a television program; and
initiate a search using said signal to facilitate identification of the television program.

12. The medium of claim 11 further storing instructions to capture an electronic decoded signal in the form of an electronic representation of a video frame or clip, audio or metadata.

13. The medium of claim 11 further storing instructions to use the detection of the passage of a time interval as an event to trigger the capturing of the electronic decoded signal.

14. The medium of claim 11 further storing instructions to transfer said signal to a mobile device.

15. The medium of claim 14 further storing instructions to provide search results to said mobile device.

16. The medium of claim 14 further storing instructions to send said signal to a remote server to perform said search.

17. The medium of claim 11 further storing instructions to track a plurality of mobile devices, receive requests from each of said devices, and provide responses to each device to enable using two different televisions at different times.

18. The medium of claim 17 further storing instructions to maintain a table correlating devices, televisions, and requests from mobile devices.

19. The medium of claim 11 further storing instructions to distribute said identification using a social networking tool.

20. The medium of claim 11 further storing instructions to capture a signal that is an electronic representation of an audio signal, convert said captured signal to text and send said text for use as an input for a keyword search.

21. An apparatus comprising:
a processor to detect the occurrence of an event, automatically capture an electronic signal from a television program in response to said event, and transmit the signal for use as an input for a keyword search; and
a storage coupled to said processor.

22. The apparatus of claim 21 wherein said apparatus is a mobile device.

23. The apparatus of claim 22 wherein said apparatus is a cellular telephone.

24. The apparatus of claim 22 wherein said apparatus is a remote control.

25. The apparatus of claim 21 wherein said apparatus is a television receiver.

26. The apparatus of claim 21 wherein said apparatus to signal a television receiving system to capture an electronic decoded signal in the form of an electronic representation of a video frame or clip, audio or metadata.

27. The apparatus of claim 21, said processor to detect an event in the form of passage of a time interval.

28. The apparatus of claim 21 wherein said apparatus to receive said signal from a television system and transmits said signal to a remote device to perform a keyword search in a database or over the Internet.

29. The apparatus of claim 28, said apparatus to automatically distribute an identification of said television program over a social networking tool.

30. The apparatus of claim 28, said apparatus to transmit said signal to a cellular telephone.
